(19) United States
(12) Patent Application Publication
(10) Pub. No.: US 2014/0111749 A1
(43) Pub. Date: Apr. 24, 2014

(54) TRANSPARENT DISPLAY PANEL AND TRANSPARENT DISPLAY APPARATUS HAVING THE SAME

(71) Applicant: SAMSUNG DISPLAY CO., LTD., Yongin-City (KR)

(72) Inventors: Byeong-Hee WON, Incheon (KR); Jong-Seo LEE, Hwaseong-si (KR); Sung-Hee HONG, Anseong-si (KR)

(73) Assignee: SAMSUNG DISPLAY CO., LTD., Yongin-City (KR)

(21) Appl. No.: 13/834,090

(22) Filed: Mar. 15, 2013

(30) Foreign Application Priority Data
Oct. 18, 2012 (KR) 10-2012-0115739

(51) Int. Cl. G02F 1/1362

(52) U.S. Cl. CPC G02F 1/136209
USPC 349/110

(57) ABSTRACT

A transparent display panel includes a first substrate, a second substrate facing the first substrate, and a liquid crystal layer between the first substrate and the second substrate. The first substrate includes a gate line set including two gate lines; a data line set including two data lines; a pixel electrode in a unit pixel area; a switching element electrically connected to a gate line, a data line and the pixel electrode; and a black matrix on the gate line set and the data line set.

This application claims priority to Korean Patent Application No. 10-2012-0115739, filed on Oct. 18, 2012, and all the benefits accruing therefrom under 35 U.S.C. §119, the contents of which are incorporated by reference herein in its entirety.

### BACKGROUND

1. Field

Exemplary embodiments of the invention relate to a transparent display panel and a transparent display apparatus including the transparent display panel. More particularly, exemplary embodiments of the invention relate to a transparent display panel increasing display quality and a transparent display apparatus including the transparent display panel.

2. Description of the Related Art

A transparent display apparatus has been developed such that a natural light supplied from a backside thereof is used for displaying an image, instead of using a separate light source such as a backlight unit. Accordingly, the transparent display apparatus displays an image through a transparent substrate as an element of the transparent display apparatus. A light that is supplied from the backside of the transparent display apparatus may go through the transparent display apparatus, so that a user at a frontside thereof can observe an image formed by using the light that is supplied from the backside, and an image formed by a light penetrating the transparent display apparatus at the same time.

Especially, the transparent display apparatus can be used to conduct a function like an augmented reality in a small display apparatus like a mobile display device. When a light that is supplied from a backside of the transparent display apparatus is used directly, a transmittance of the light that is supplied from the backside should be kept high and a distortion of a light by diffraction should be prevented.

### SUMMARY

One or more exemplary embodiment of the invention provides a transparent display panel increasing a transmittance ratio and preventing a distortion of images.

One or more exemplary embodiment of the invention also provides a transparent display apparatus having the above-mentioned transparent display panel.

According to an exemplary embodiment of the invention, a transparent display panel includes a first substrate, a second substrate facing the first substrate, and a liquid crystal layer between the first and second substrates. The first substrate includes a gate line set including two gate lines; a data line set including two data lines; a pixel electrode in a unit pixel area; a switching element electrically connected to a gate line, a data line and the pixel electrode; and a black matrix on the gate line set and the data line set.

In an exemplary embodiment, the transparent display panel may include a plurality of unit pixel areas which may include a first unit pixel area, a second unit pixel area and a third unit pixel area.

In an exemplary embodiment, the first unit pixel area may display red and green colors, the second unit pixel area may display blue and red colors and the third unit pixel area may display green and blue colors.

In an exemplary embodiment, the transparent display panel may include four pixel electrodes in the unit pixel area.

In an exemplary embodiment, the unit pixel area may display green, blue, red or white colors.

In an exemplary embodiment, the black matrix may include a gate black matrix covering the gate line set.

In an exemplary embodiment, the black matrix may include a data black matrix covering the data line set.

In an exemplary embodiment, the black matrix may overlap only the gate line set, and expose the data line set.

In an exemplary embodiment, the transparent display panel may further include a common electrode overlapping the exposed data line set.

In an exemplary embodiment, the black matrix may overlap an area where the gate line set and the data line set cross each other.

In an exemplary embodiment, the black matrix may cover the switching element.

In an exemplary embodiment, the black matrix may expose remaining areas of the gate line set and the data line set.

In an exemplary embodiment, the transparent display panel may further include a common electrode overlapping the exposed remaining areas of the gate line set and the data line set.

According to another exemplary embodiment of the invention, a transparent display apparatus includes a transparent display panel which display an image; and a driving member which drives the transparent display panel and includes a driving circuit. The transparent display panel includes a first substrate including: a gate line set including two gate lines, a data line set including two data lines, a pixel electrode in a unit pixel area, a switching element electrically connected to a gate line, a data line and the pixel electrode, and a black matrix on the gate line set and the data line set; a second substrate including a common electrode; a liquid crystal layer between the first substrate and the second.

In an exemplary embodiment, the transparent display panel may further include four pixel electrodes in the unit pixel area.

In an exemplary embodiment, the black matrix may include a gate black matrix covering the gate line set.

In an exemplary embodiment, the black matrix overlaps only the gate line set, and exposes the data line set, and the common electrode overlaps the exposed data line set.

In an exemplary embodiment, the black matrix may include a data black matrix covering the data line set.

In an exemplary embodiment, the black matrix may overlap a crossing area of the gate line set and the data line set.

In an exemplary embodiment, the black matrix exposes remaining areas of the gate line set and the data line set, and the common electrode may overlap the exposed remaining areas of the gate line set and the data line set.

According to one or more exemplary embodiment of the invention, a display panel of a transparent display apparatus includes a decreased area in which a black matrix is disposed by disposing a gate line set including two gate lines and a data line set including two data lines therein.

Thus, a spacing distance between black matrices is extended so that light diffraction of light which is transmitted from a backside of the transparent display apparatus can be decreased. Consequently, a decrease of image brightness of the transparent display apparatus can be reduced or effectively prevented so that the transparent display apparatus can display a higher quality image.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a perspective view illustrating an exemplary embodiment of a transparent display panel according to the invention;

FIG. 2 is a circuit diagram illustrating the transparent display panel in FIG. 1;

FIGS. 3A and 3B are perspective views illustrating paths of light with respect to a conventional pixel structure and an exemplary embodiment of a pixel structure according to the invention;

FIG. 4 is a perspective view illustrating another exemplary embodiment of a transparent display panel according to the invention;

FIG. 5 is a perspective view illustrating still another exemplary embodiment of a transparent display panel according to the invention;

FIG. 6 is a perspective view further illustrating still another exemplary embodiment of a transparent display panel according to the invention;

FIG. 7 is a circuit diagram illustrating the transparent display panel in FIG. 6;

FIG. 8 is a perspective view further illustrating still another exemplary embodiment of a transparent display panel according to the invention.

### DETAILED DESCRIPTION

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “under” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be explained in detail with reference to the accompanying drawings.

In a liquid crystal display apparatus, black matrices blocking a light are disposed very densely. Where the liquid crystal display apparatus is used as a transparent display apparatus, especially for a small display apparatus, because a cell size is very small, a transmittance ratio of an image may be decreased and images formed by a light that is supplied from a backside of the liquid crystal apparatus may be distorted, such that image display quality is undesirably reduced and a user is dissatisfied with the reduced display quality. Therefore, there remains a need for an improved transparent liquid crystal display panel for a liquid crystal display apparatus having an increased image transmittance ratio and displaying un-distorted images using light supplied from a backside of the liquid crystal display apparatus.

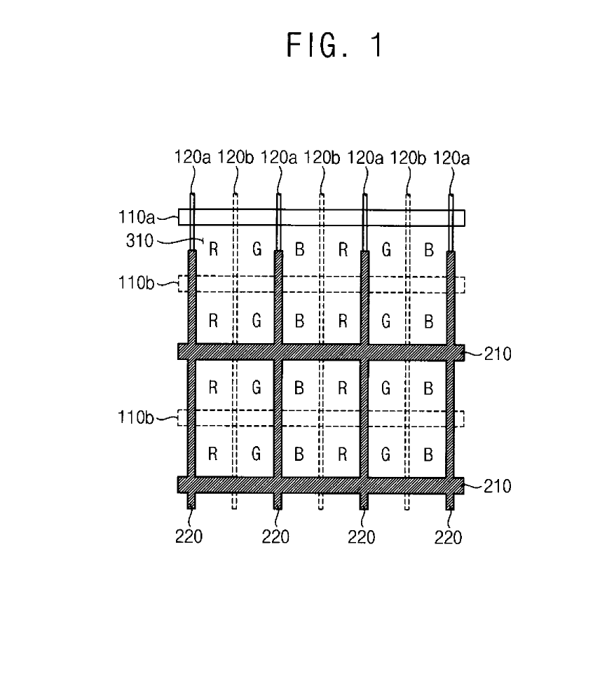

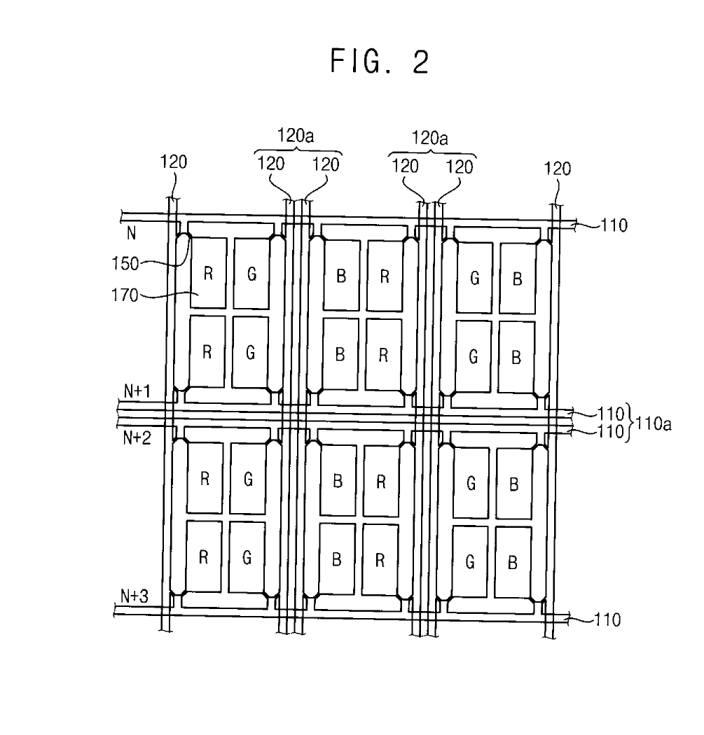

FIG. 1 is a perspective view illustrating an exemplary embodiment of a transparent display panel of a liquid crystal display apparatus according to the invention. FIG. 2 is a circuit diagram illustrating the transparent display panel in FIG. 1.

Referring to FIGS. 1 and 2, an exemplary embodiment of a transparent display panel according to the invention includes a first substrate, one or more gate line set 110a, one or more data line set 120a, one or more pixel electrode 170, one or more switching element 150, a collective black matrix member includes a plurality of black matrices 210 and 220, a second substrate and a liquid crystal layer. The first substrate may include the gate line set 110a, the data line set 120a, the pixel electrode 170, the switching element 150 and the black matrix, on a first base substrate.

A gate line set 110a collectively includes two gate lines 110. The gate line set 110a includes N−1th and Nth gate lines 110 or N+1th and N+2th gate lines 110. The gate line set 110a is elongated in a first direction (e.g. left-right in FIG. 1). Because the gate line set 110a collectively includes two gate lines 110, a space for a conventional arrangement of spaced apart gate lines 110b does not need to be provided.

The data line set 120a collectively includes two data lines 120. The data line set 120a includes N−1th and Nth data lines 120 or N+1th and N+2th data lines 120. The data line set 120a is elongated in a second direction (e.g., top-down in FIG. 1) which crosses the first direction. Because the data line set 120a collectively includes two data lines 120, a space for a conventional arrangement of spaced apart data lines 120b does not need to be provided.

Because the gate line set 110a and the date line set 120a include two gate lines 110 and two data lines 120, respectively, even though a unit pixel area 310 includes at least two pixel electrodes adjacent to each other, the unit pixel area 310 do not include an individual and separate data line 120 or gate line 110 (dotted line boxes in FIG. 1) between the adjacent pixel electrodes 170. Thus, a spacing distance between adjacent gate line sets 110a and/or adjacent data line sets 120a is at least two times greater than a spacing distance between adjacent conventional gate lines or adjacent conventional data lines.

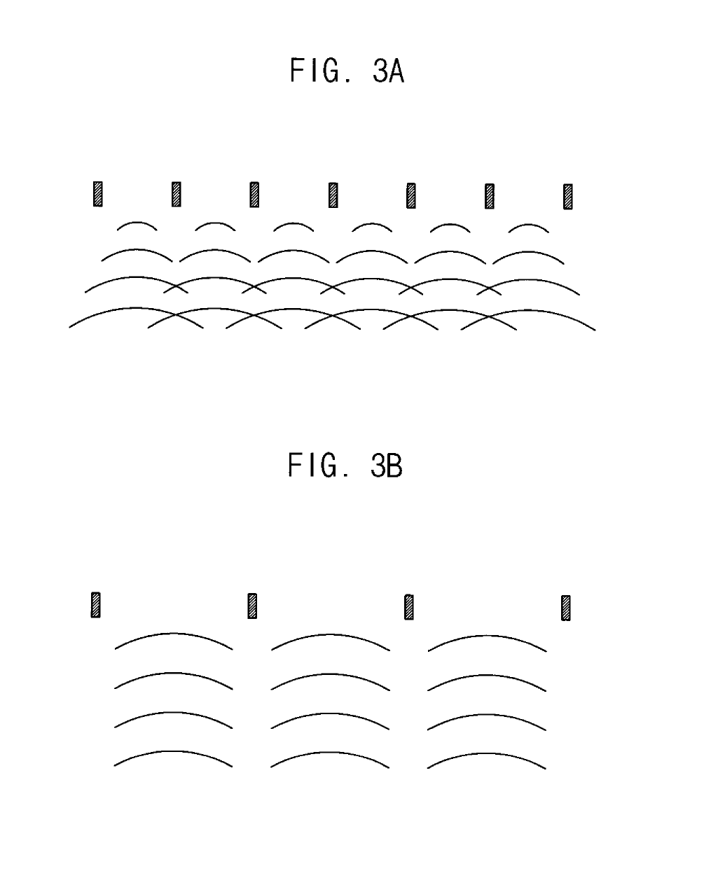

FIGS. 3A and 3B are perspective views illustrating paths of light with respect to a conventional pixel structure and an exemplary embodiment of a pixel structure according to the invention.

According to Huygens' principle, as a width of a slit between adjacent light-blocking elements becomes narrower, diffraction of a light or wave transmitted through the slit becomes larger. In a display apparatus, as light diffraction becomes larger, an image displayed on a screen thereof is increasingly blurred. Furthermore, a transparent display apparatus using a transparent display panel does not use a limited light from backlight unit, but uses various light sources which generates and supplies light from a backside of the transparent display panel and/or the transparent display apparatus. Accordingly, when the displayed image is blurred by a diffraction phenomenon, recognition of the image by a user may be deteriorated. Furthermore, when a light is diffracted in wrong or undesirable directions, brightness of the displayed image may be decreased, so that a screen of the transparent display apparatus displays a darker image such as displaying more black overall.

Referring to FIG. 3A, in a conventional pixel structure, where a black matrix which blocks light defines a relatively narrow gap or an area (e.g., a slit) therebetween through which light passes, a light passing through the relatively narrow slit is largely diffracted. The overlapping arcs in FIG. 3A illustrate light that spreads out and deviates from an original straight path. Accordingly, a light supplied from a backside of a display apparatus including the conventional pixel structure and passing through slits between black matrices refracts and spreads out, so that images displayed on a display panel of the display apparatus are distorted and a screen of the display apparatus displays darker images or more black overall.

Referring to FIG. 3B, in an exemplary embodiment of a pixel structure according to the invention, where a black matrix which blocks light defines a relatively wide gap or area (e.g., a slit) therebetween through which light passes, a linear or straight path of the light passing through the slit may be maintained. The non-overlapping arcs in FIG. 3B illustrate light that does not spread out and does not deviate from an original straight path. Accordingly, since a light supplied from a backside of a display apparatus including the exemplary embodiment of the pixel structure may be transferred to a user at a frontside of the display apparatus through slits between black matrices without minimal light loss or deviation from the straight path, a diffraction phenomenon is decreased so that images displayed on a display panel of the display apparatus are not distorted and a screen of the display apparatus displays a brighter image overall.

Referring again to FIG. 2, at least two pixel electrodes 170 are disposed in a unit pixel area 310. A unit pixel area 310 may be defined by adjacent gate line sets 110a and data line sets 120a which respectively cross each, but the invention is not limited thereto or thereby. In the exemplary embodiment illustrated in FIG. 2, for example, the unit pixel area 310 is defined by adjacent gate line sets 110a and adjacent data line sets 120a which respectively cross each other. Each pixel electrode 170 of a plurality of pixel electrodes 170 in the unit pixel area 310 may respectively display different colors, and may display a desired image by mixing a plurality of main colors. Furthermore, a switching element 150 is electrically connected to a gate line 110 of a collective gate line set 110A and a data line 120 of a collective data line set 120a, and drives the pixel electrode 170.

Referring again to FIG. 1, the black matrices 210 and 220 are disposed on (e.g., above towards a frontside or viewing side of) the gate line set 110a and the data line set 120a, respectively, and reduce or effectively prevent light leakage that may be generated by the gate line set 110a and the data line set 120a. The In FIG. 1, the black matrices 210 and 220 are shown as shaded regions over the un-shaded gate line set 110a and data line set 120a. The black matrices 210 and 220 in FIG. 1 do not cover all of the un-shaded gate line sets 110a and data line sets 120a for purpose of explanation, but it will be understood that the black matrices 210 and 220 may cover an entire of the gate line sets 110a and data line sets 120a.

The second substrate, which may be separately formed, is combined with first substrate to form a transparent liquid crystal display panel, which may also be hereinafter referred to as a transparent display panel. The liquid crystal layer is disposed between the first substrate and the second substrate.

The transparent liquid crystal display panel may include a plurality of unit pixel areas 310, and the plurality of unit pixel areas 310 may be respectively defined by the gate line sets 110a and the data line set 120a, but the invention is not limited thereto or thereby. In one exemplary embodiment, the transparent liquid crystal display panel may include a first unit pixel area, a second unit pixel area and a third unit pixel area. The first unit pixel area 310, the second unit pixel area 310 and the third unit pixel area 310 may have the same or similar structure, except for different color patterns. In one exemplary embodiment, the first unit pixel area 310 may display red and green, the second unit pixel area 310 may display blue and red, and the third unit pixel area 310 may display green and blue. Accordingly, the first unit pixel area 310, the second unit pixel area 310 and the third unit pixel area 310 may respectively form a unit pixel including two colors of red (R), two colors of green (G) and two colors of blue (B). The first to third unit pixel areas 310 may be arranged in a pixel row which extends in a direction, such as the first direction (e.g., left-right) in FIG. 2, but the invention is not limited thereto or thereby.

Additionally, the black matrices 210 and 220 include a gate black matrix 210 covering (e.g., overlapping) the gate line set 110a. The gate black matrix 210 covers the gate line set 110a and reduces or effectively prevents light leakage that may occur at the gate lines of the gate line set 110a. The gate black matrix 210 has a longitudinal axis elongated in the first direction, and has a width perpendicular to the longitudinal axis which is twice a width of a conventional black matrix. A plurality of gate black matrices 210 is elongated in the first direction, while being spaced apart from each other in the second direction. Accordingly, effects of diffraction of light supplied from a backside of the transparent display panel may be reduced, to thereby improve image display brightness.

The black matrices 210 and 220 further include a data black matrix 220 covering the data line set 120a. The data black matrix 220 covers the data line set 120a and reduces or effectively prevents light leakage that may occur at the data lines of the data line set 120a. The data black matrix 220 may have a similar structure to the gate black matrix 210. A plurality of data black matrices 220 is elongated in the second direction, while being spaced apart from each other in the first direction. Accordingly, effects of diffraction of light supplied from a backside of the transparent display panel may be reduced, thereby improving image display brightness.

As illustrated in FIG. 1 and FIG. 2, a single gate black matrix 210 may cover two gate lines 110 which are adjacent to each other. However, in an alternative exemplary embodiment, the gate black matrix 210 may cover each of the gate lines 110 individually and be spaced apart from each other. Similarly, a single data black matrix 220 may cover two data lines 120 which are adjacent to each other. However, in an alternative exemplary embodiment, the data black matrix 220 may cover each of the data lines 120 individually and be spaced apart from each other. The plurality of gate black matrices 210 and the plurality of data black matrices 220 may be interconnected with each other, so as to form a single, unitary, indivisible member, but the invention is not limited thereto or thereby.

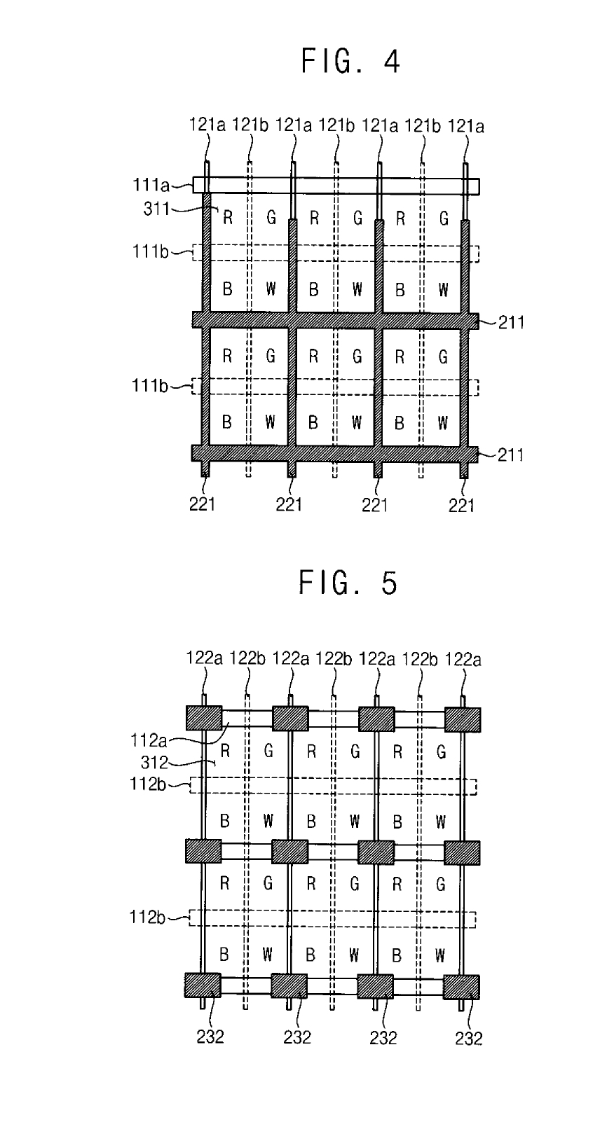

FIG. 4 is a perspective view illustrating another exemplary embodiment of a transparent display panel according to the invention.

Referring to FIG. 4, an exemplary embodiment of a transparent display panel according to the invention includes a first substrate, one or more gate line set 111a, one or more data line set 121a, one or more pixel electrode, one or more switching element, black matrices 211 and 221, a second substrate and a liquid crystal layer.

A gate line set 111a collectively includes two gate lines. Because the gate line set 111a includes two gate lines, a space for a conventional arrangement of spaced apart gate lines 111b does not need to be provided. A data line set 121a includes two data lines. Because the data line set 121a includes two data lines, a space for a conventional arrangement of spaced apart data lines 121b does not need to be provided.

Because the gate line set 111a and the date line set 121a include two gate lines and two data lines respectively, even though a unit pixel area 311 includes at least two pixel electrodes, the unit pixel area 311 do not include an individual or separate data line or gate line between adjacent pixel electrodes. Thus, a spacing distance between adjacent gate line sets 111a or between adjacent data line sets 121a is greater than a spacing distance between adjacent conventional gate lines or adjacent conventional data lines.

In the exemplary embodiment shown in FIG. 4, the unit pixel area 311 includes four pixel electrodes. In addition, the four pixel electrodes of one unit pixel area 311 may display main colors such as green, blue, red and white, respectively. However, the main colors displayed by one unit pixel area 311 is not limited to green, blue, red and white. When four colors which are green, blue, red and white are displayed in one unit pixel area 311, a desired color may be displayed by using the four main colors.

Additionally, the black matrices 211 and 221 include a gate black matrix 211 covering the gate line set 111a. The gate black matrix 211 covers the gate line set 111a and reduces or effectively prevents light leakage that may occur at the gate lines of the gate line set 111a. Furthermore, the black matrices 211 and 221 further include a data black matrix 221 covering the data line set 121a. The data black matrix 221 covers the data line set 121a and reduces or effectively prevents light leakage that may occur at the data lines of the data line set 121a. The gate black matrix 211 and the data black matrix 221 are twice as wide as a conventional black matrix. Accordingly, diffraction of light that is supplied from a backside of the transparent display panel may be reduced, thereby improving image display brightness.

FIG. 5 is a perspective view illustrating still another exemplary embodiment of a transparent display panel according to the invention.

Referring to FIG. 5, an exemplary embodiment of a transparent display panel according to the invention includes a first substrate, one or more gate line set 112a, one or more data line set 122a, one or more pixel electrode, one or more switching element, one or more black matrix 232, a second substrate and a liquid crystal layer.

The gate line set 112a collectively includes two gate lines. Because the gate line set 112a includes two gate lines, a space for a conventional arrangement of gate lines 112b does not need to be provided. The data line set 122A collectively includes two data lines. Because the data line set 122a includes two data lines, a space for a conventional arrangement of data lines 122b does not need to be provided.

Because the gate line set 112a and the date line set 122a include two gate lines and two data lines respectively, even though a unit pixel area 312 includes at least two pixel electrodes, the unit pixel area 312 do not include an individual or separate data line or gate line between adjacent pixel electrodes. Accordingly, a spacing distance between adjacent gate line sets 112a and adjacent data line sets 122a is increased greater than a spacing distance between adjacent conventional gate lines or adjacent conventional data lines.

In the exemplary embodiment shown in FIG. 5, the unit pixel area 312 includes four pixel electrodes. The transparent display panel may include a plurality of unit pixel areas 312 each including four pixel electrodes. Additionally, the four pixel electrodes of unit pixel area 312 may respectively display main colors such as green, blue, red and white. When four colors which are green, blue, red and white are displayed in one unit pixel area 312, a desired color may be displayed by using the four main colors.

Additionally, a plurality of black matrices 232 may be respectively disposed on a crossing area of the gate line set 112a and the data line set 122a. The black matrices 232 having a discrete patterned shape are disposed only on the crossing area of the gate line set 112a and the data line set 122a, so that other areas of the gate line set 112a and the data line 122a set may be exposed by the patterned black matrices 232. Accordingly, diffraction of light that is caused by the black matrices 232 is reduced, so that more light may transmit through the transparent display panel from a backside thereof.

However, in case that a gate line of the gate line set 112a and a data line of the data line set 122a may be exposed, because the black matrices 232 are disposed only on the crossing area of the gate line set 112a and the data line set 122a, and therefore at a crossing area of the gate lines and the data lines of the gate line set 112a and the data line set 122a, light leakage occurs at remaining areas of the gate lines and the data lines where the black matrices 232 are not disposed. To prevent the light leakage at these remaining areas of the gate lines and/or the data lines, the transparent display panel may further include one or more common electrode disposed on and overlapping the gate line set 112a and/or the data line set 122a. The common electrode may be not only used to form a fringe field in cooperation with the pixel electrode for controlling an arrangement of a liquid crystal of the liquid crystal layer, but may also be used to reduce or effectively prevent the light leakage occurring at the remaining areas of the gate lines and/or the data lines. The first substrate or the second substrate may include the common electrode.

Accordingly, an area or space occupied by the black matrices 232 may be smaller than that of a conventional black matrix. Accordingly, diffraction of light supplied from a backside of the transparent display panel is reduced, thereby improving image display brightness. A switching element is electrically connected to a gate line and a data line. The black matrix 232 may be disposed to cover the switching element, but is not limited thereto or thereby.

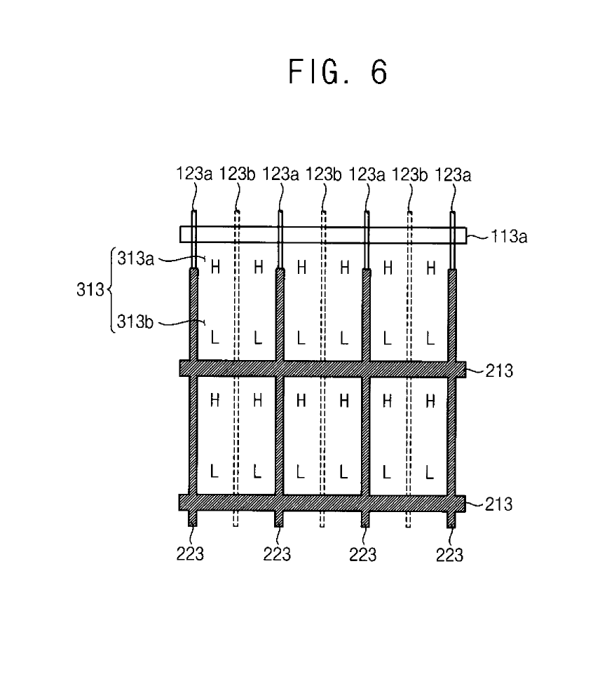

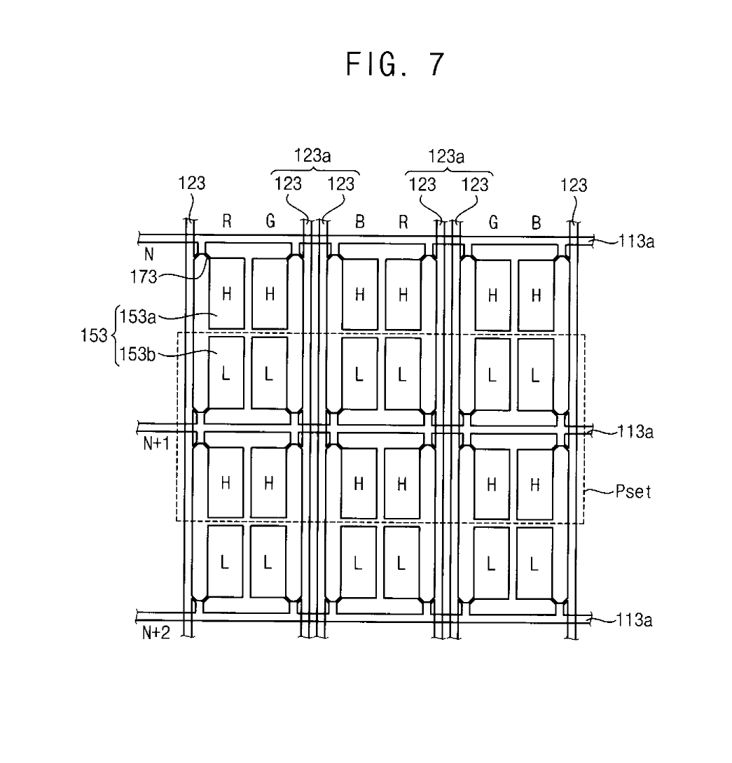

FIG. 6 is a perspective view further illustrating still another exemplary embodiment of a transparent display panel according to the invention. FIG. 7 is a circuit diagram illustrating the transparent display panel in FIG. 6.

Referring to FIGS. 6 and 7, an exemplary embodiment of a transparent display panel according to the invention includes a first substrate, one or more gate line 113a, one or more data line set 123a, one or more pixel electrode 153, one or more switching element 173, black matrices 213 and 223, a second substrate and a liquid crystal layer.

A gate line 113a in the illustrated exemplary embodiment is a single gate line. A pixel electrode 153 may include a first subpixel electrode 153a and a second subpixel electrode 153b. The first subpixel electrode 153a may be a high subpixel electrode to which a first voltage is applied, and the second subpixel electrode 153b may be a low subpixel electrode to which a second voltage lower than the first voltage is applied. In the illustrated exemplary embodiment, the single gate line 113a drives two pixel electrodes 153, respectively. The unit pixel area 313 is divided into a high pixel region 313a and a low pixel region 313b, corresponding to the first and second subpixel electrodes 153a and 153b, respectively. The high pixel region 313a may collectively include adjacent high pixel regions corresponding to adjacent first subpixel electrodes 153a in the single unit pixel area 313. Similarly, the low pixel region 313b may collectively include adjacent low pixel regions corresponding to adjacent second subpixel electrodes 153b in the same unit pixel area 313.

The subpixel electrodes 153a and 153b of adjacent pixel electrodes 153 the unit pixel area 313 are driven by one single gate signal transmitted by the single gate line. Different from other exemplary embodiments described above, the exemplary embodiment of FIG. 6 and FIG. 7, does not include a gate line set having multiple gate lines, but instead the transparent display panel includes only single gate lines spaced apart from each other. Because the data line set 123a includes two data lines, a space for a conventional arrangement of data lines 123b does not need to be provided.

Because the data line set 123a includes two data lines, even though the unit pixel area 313 includes at least two pixel electrodes, the unit pixel area 313 does not include any data line between adjacent pixel electrodes. Accordingly, a spacing distance between adjacent data line sets 123a is increased and is at least twice a spacing distance between conventional data lines.

The unit pixel area 313 may be defined by adjacent gate lines 113a and adjacent data line sets 123a which respectively cross each, but the invention is not limited thereto or thereby. In the exemplary embodiment illustrated in FIG. 7, for example, the unit pixel area 313 is defined by adjacent single gate lines 113a and adjacent data line sets 123a which respectively cross each other, and includes four subpixel electrodes. As noted above, the gate line 113a is a single gate line. Accordingly, two switching elements 173 of one unit pixel area 313, which are respectively connected to two subpixel electrodes, are electrically connected to one gate line 113a. Furthermore, two pixel electrodes 153 of adjacent unit pixel areas 313 share the same gate line and are disposed adjacent to each other in the second direction. The same gate line may be disposed between the two pixel electrodes 153 of the adjacent unit pixel areas 313, but the invention is not limited thereto or thereby. Thus, one unit pixel (Pset) may include portions of adjacent unit pixel areas 313 and the same gate line disposed between the portions of the adjacent unit pixel areas 313. In contrast, the unit pixel shown in FIG. 2 is completely between two adjacent gate lines 110.

As in the exemplary embodiment of FIG. 1, the transparent display panel may include a plurality of unit pixel areas 313. The plurality of unit pixel areas 313 each including four pixel electrodes may include a first unit pixel area 313, a second unit pixel area 313 and a third unit pixel area 313, respectively. The first unit pixel area 313 may display red and green, the second unit pixel area 313 may display blue and red, the third unit pixel area 313 may display green and blue. Additionally, the four subpixel electrodes of the unit pixel area 313 may display green, blue, red and white, respectively.

Additionally, the black matrices 213 and 223 include a gate black matrix 213 covering the gate line 113a. The gate black matrix 213 covers the gate line 113a and reduces or effectively prevents light leakage that may occur at the gate line 113a. Furthermore, the black matrix further includes a data black matrix 223 covering the data line set 123a. The data black matrices 223 covers the data line set 123a and prevents a light leakage that may occur at the data line of the data line set 123a. The gate black matrix 213 and the data black matrix 223 have a width that is twice a width of a conventional black matrix. Accordingly, diffraction of light supplied from a backside of the transparent display panel may occur less, thereby improving image display brightness.

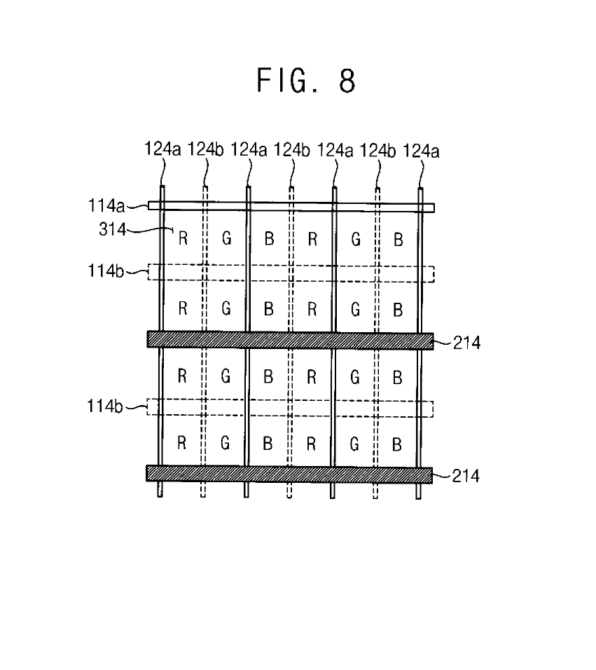

FIG. 8 is a perspective view further illustrating still another exemplary embodiment of a transparent display panel according the invention.

Referring to FIG. 8, an exemplary embodiment of a transparent display panel according to the invention includes a first substrate, one or more gate line set 114a, one or more data line set 124a, one or more pixel electrode, one or more switching element, one or more black matrix 214, a second substrate and a liquid crystal layer.

A gate line set 114a includes two gate lines. Because the gate line set 114a include two gate lines, a space for a conventional arrangement of gate lines 114b does not need to be provided. The data line set 124a includes two data lines. Because the data line set 124a includes two data lines, a space for a conventional arrangement of data lines 124b does not need to be provided.

Because the gate line set 114a and the date line set 124a include two gate lines and two data lines, respectively, even though a unit pixel area 314 includes at least two pixel electrodes, the unit pixel area 314 do not include an individual or separate data line or gate line between adjacent to pixel electrodes. Accordingly, a spacing distance between adjacent gate line sets 114a or between the adjacent data line sets 124a is twice a spacing distance between conventional adjacent gate lines or conventional adjacent data lines.

Additionally, a plurality of black matrices 214 are respectively disposed on the gate line sets 114a. The black matrices 214 are disposed only on the gate line sets 114a, so that the data line sets 114a may be exposed by the black matrices 214. Substantially, effects of diffraction due to the data lines of the data line sets 124a may be smaller than effects of diffraction due to the gate lines of the gate line sets 114a. Accordingly, the black matrices 214 are disposed only on an area corresponding to the gate line sets 114a. To reduce or effectively prevent light leakage, the transparent display panel may further include a common electrode on (e.g., overlapping) the data line sets 124a exposed by the black matrices 214. The common electrode is not only used to form a fringe field in cooperation with the pixel electrode for controlling an arrangement of a liquid crystal in the liquid crystal layer, but also may be used to reduce or effectively prevent light leakage that may occur at the gate lines and the data lines, by applying regular voltages.

Thus, an area or space occupied by the black matrices 214 may be smaller than that of conventional black matrices. Accordingly, diffraction of light supplied from a backside of the transparent display panel may be reduced, thereby improving image display brightness.

A transparent display apparatus may include a transparent display panel according to any one of the exemplary embodiments described above. That is, the transparent display apparatus may include a transparent display panel, and a driving member driving the transparent display panel including a driving circuit. The transparent display panel may include a first substrate including a gate line set including two gate lines, a data line set including two data lines, a pixel electrode in a unit pixel area, a switching element electrically connected to a gate line, a data line and the pixel electrode and a black matrix on the gate line set and the data line set, a second substrate including a common electrode, and a liquid crystal layer between the first substrate and the second substrate.

According to one or more exemplary embodiment of the invention, a transparent display panel includes a gate line set including two gate lines and a data line set including two data lines may be provided to reduce a space occupied by black matrices which overlap the gate and data line sets.

Since a gate line set including two gate lines and a data line set including two data lines, a spacing distance between the black matrices overlapping the gate and data line sets is increased, so that effects of diffraction of light supplied from a backside of the transparent display panel may be reduced and decrease of an image brightness may be reduced or effectively prevented, to thereby improve image display quality of the transparent display panel.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A transparent display panel comprising:
a first substrate comprising;
a gate line set comprising two gate lines;
a data line set comprising two data lines;
a pixel electrode in a unit pixel area;
a switching element electrically connected to a gate line, a data line and the pixel electrode;
a black matrix on the gate line set and the data line set;
a second substrate facing the first substrate;
a liquid crystal layer between the first substrate and the second substrate.

2. The transparent display panel of claim 1, further comprising a plurality of unit pixel areas comprising a first unit pixel area, a second unit pixel area and a third unit pixel area.

3. The transparent display panel of claim 2, wherein the first unit pixel area displays red and green colors, the second unit pixel area displays blue and red colors, and the third unit pixel area displays green and blue colors.

4. The transparent display panel of claim 1, further comprising four pixel electrodes in the unit pixel area.

5. The transparent display panel of claim 4, wherein the unit pixel area displays green, blue, red and white colors.

6. The transparent display panel of claim 1, wherein the black matrix comprises a gate black matrix covering the gate line set.

7. The transparent display panel of claim 6, wherein the black matrix further comprises a data black matrix covering the data line set.

8. The transparent display panel of claim 1, wherein the black matrix overlaps only the gate line set, and exposes the data line set.

9. The transparent display panel of claim 8, further comprising:
a common electrode overlapping the exposed data line set.

10. The transparent display panel of claim 1, wherein the black matrix overlaps an area where the gate line set and the data line set cross each other.

11. The transparent display panel of claim 10, wherein the black matrix covers the switching element.

12. The transparent display panel of claim 10, wherein the black matrix exposes remaining areas of the gate line set and the data line set.

13. The transparent display panel of claim 12, further comprising:
a common electrode overlapping the exposed remaining areas of the gate line set and the data line set.

14. A transparent display apparatus comprising:
a transparent display panel which display an image; and
a driving member which drives the transparent display panel and comprises a driving circuit;
the transparent display panel comprising:
a first substrate comprising:
a gate line set comprising two gate lines,
a data line set comprising two data lines,
a pixel electrode in a unit pixel area,
a switching element electrically connected to a gate line, a data line and the pixel electrode, and
a black matrix on the gate line set and the data line set;
a second substrate comprising a common electrode;
a liquid crystal layer between the first substrate and the second substrate.

15. The transparent display apparatus of claim 14, further comprising four pixel electrodes in the unit pixel area.

16. The transparent display apparatus of claim 14, wherein the black matrix comprises a gate black matrix covering the gate line set.

17. The transparent display apparatus of claim 16, wherein
the black matrix overlaps only the gate line set, and exposes the data line set, and
the common electrode overlaps the exposed data line set.

18. The transparent display apparatus of claim 16, wherein the black matrix comprises a data black matrix covering the data line set.

19. The transparent display apparatus of claim 14, wherein the black matrix overlaps a crossing area of the gate line set and the data line set.

20. The transparent display apparatus of claim 19, wherein
the black matrix exposes remaining areas of the gate line set and the data line set, and
the common electrode overlaps the exposed remaining areas of the gate line set and the data line set.
